(19) United States
(12) Patent Application Publication
(10) Pub. No.: US 2024/0271987 A1
(43) Pub. Date: Aug. 15, 2024

(54) METHOD FOR DETERMINING THE WHEEL LOAD OR AXLE LOAD OF AN AIR-SPRUNG VEHICLE

(71) Applicant: ZF CV Systems Europe BV, Brussels (BE)

(72) Inventors: Felix Diet, Rodenberg (DE); Wolfgang Uwe Riedel-Kujas, Rodewald (DE); Christian Schrader, Peine (DE); Axel Stender, Hameln (DE)

(21) Appl. No.: 18/646,406

(22) Filed: Apr. 25, 2024

Related U.S. Application Data
(63) Continuation of application No. PCT/EP2022/076569, filed on Sep. 23, 2022.

(30) Foreign Application Priority Data
Oct. 25, 2021 (DE) 10 2021 127 655.1

(51) Int. Cl. G01G 19/10; B60G 17/052; G01G 5/00

(52) U.S. Cl. CPC G01G 19/10; B60G 17/052; G01G 5/006; B60G 2202/152; B60G 2400/64; B60G 2500/30

(57) ABSTRACT

A method for determining the wheel load or axle load of an air-sprung vehicle by measuring the internal pressure of the air spring, wherein the wheel load or axle load is determined using a pressure curve which represents the relationship between a bearing force acting on the air spring and the internal pressure of the air spring, characterized in that starting from a wheel load or axle load determined by pressure measurement, using an original pressure curve of an air spring which has been newly brought into operation, further pressure measurements are carried out using pressure curves which, in comparison with the original pressure curve, show a change reflecting the aging of the air spring.

### CROSS-REFERENCE TO RELATED APPLICATIONS

This application is a continuation application of international patent application PCT/EP2022/076569, filed Sep. 23, 2022, designating the United States and claiming priority from German application 10 2021 127 655.1, filed Oct. 25, 2021, and the entire content of both applications is incorporated herein by reference.

### TECHNICAL FIELD

The disclosure concerns a method for determining the wheel load or axle load of an air-sprung vehicle by measuring the internal pressure of at least one air spring, wherein the wheel load or axle load is determined using a pressure curve which represents the relationship between a bearing force acting on the air spring and an internal pressure of the air spring.

### BACKGROUND

Trucks or goods vehicle trailers with conventional or electronic air suspension have air springs which are arranged in the chassis as suspension elements for springing the axles or wheels. One or more air springs may be provided on each side of the axle.

The air springs is made of elastomer material, substantially rubber, which may be composed of various material layers and usually has embedded strength carriers. Air springs, like most synthetic materials, are subject to aging which may be influenced by external influences such as direct sunlight, ozone, heat from the vicinity of the engine or exhaust system, and also by cleaning agents or lubricants.

Because of the constant internal pressure loading, as aging progresses, a change in the air springs may be reflected in a change of their effective area or diameter over the service life. Such a change naturally has effects on determining the wheel load or axle load if these are determined via the pressure curve of the spring. If the effective diameter increases due to aging, for the same axle load lower pressure values may exist. Conversely, when determining the axle load purely via the internal spring pressure or system pressure of the air spring, over time and after corresponding aging, for the same pressure value a correspondingly higher wheel load or axle load may be present.

Already today and increasingly in the near future, legal regulations apply which require controlled measurement of the wheel load or axle load to be possible at all times. Thus for example the future implementation order EU 2019/1213 by the European Commission contains regulations and conditions for on-board measurement and weighing systems, which must ensure that, on measurement via the internal pressure of an air spring, firstly sufficient accuracy is achieved and secondly such a measurement provides valid results over the operational life.

In order to take account of the aging of springs in air suspension systems, already today it is usual to carry out regular calibration in order to determine an actual pressure curve for the air springs which corresponds to the change in the springs due to aging. The calibrated value is transmitted to the corresponding devices and also transferred to display devices or telematics systems.

However, calibration of the pressure curve or axle load curve under the conditions still widely applicable today is a relatively complex process. Calibration takes place at regular intervals by performance of weight-dependent measurements, namely measurements on an unloaded, a partially loaded and a fully loaded vehicle. Then the resulting curve, substantially determined by these three measurement points, is stored in a control unit. Such calibration must therefore be carried out repeatedly over the service life.

The disadvantage with such calibration at three different load states is that a weighing device is required, and the load state must be changed at least three times during calibration. Alternatively, calibration may be spread over various times at which a suitable load is—by chance—present; such calibration is however very time-consuming and also requires experienced personnel and corresponding stationary devices.

However, in the prior art, methods are already known in which such calibration is replaced by automated adaptation, namely methods for automatically determining the load acting on the air springs and take into account the aging of the suspension means, that is, the air springs.

Thus for example DE 10 2017 008 973 A1 describes a method for determining the load of a vehicle with an air suspension system, wherein the load is determined on the basis of the pressure in the suspension means and the aging of the suspension means. Therefore, firstly, the influence of aging of the suspension means is determined, in that, for example, load cycles or vibrations during operation are collected and their influence on aging determined, or in that the aging of the suspension means can be concluded on the basis of temperature developments or the frequency of body lowering and raising.

The models inherent in such a process require not only considerable computing complexity but also take into account “external” variables and load collectives of many assemblies and devices of the entire vehicle, which are also influenced by the respective gross mass of the load and vehicle. These models therefore contain many parameters which describe effects of aging on means or objects other than those directly belonging to the air spring or air spring environment, so that in principle for every vehicle, a plurality of different specific parameters must be used. A simple and general applicability of the method to different vehicles and vehicle types is therefore more difficult.

### SUMMARY

It is an object of the present disclosure to provide an improved and simplified method for determining the wheel load or axle load of air-sprung vehicles, which is easy to automate and allows secure and rapid measurement of wheel loads and axle loads for different vehicles, loads and application areas; in particular, determination of the wheel loads and axle loads for trucks and truck trailers in accordance with legal regulations.

This object is, for example, achieved by a method for determining a wheel load or an axle load of an air-sprung vehicle. The method includes: measuring the internal pressure of an air spring and determining the wheel load or the axle load using an original pressure curve which represents a relationship between a bearing force acting on the air spring and the measured internal pressure of the air spring; and, starting from a wheel load or axle load determined by the pressure measurement, using the original pressure curve of an air spring which has been newly brought into operation, performing further pressure measurements using a further pressure curve which, in comparison with the original pressure curve, shows change reflecting an aging of the air spring.

Starting from a wheel load or axle load of an air-sprung vehicle, in particular an air-sprung goods vehicle, for example, a tractor or truck trailer, determined by pressure measurement using an original pressure curve of an air spring which has been newly brought into operation, further pressure measurements are carried out using pressure curves which, in comparison with the original pressure curve, show a change reflecting the aging of the air spring. Where this text refers to “pressure measurements”, this means the measurement of the internal pressure of an air spring or, if identical due to the respective construction of the air suspension system, the system pressure in the air suspension. Similarly, the pressure curve means the characteristic curve which depicts the correlation between the effective spring diameter and the axial force or load acting on the spring.

Because of such pressure curves, which already include the changes determined over the operating period using previous experience, tests and measurements, there is no need for repetitive complex calibrations and repeated redetermination of the current applicable pressure curve. The structure of such pressure curves which reflect changes induced by aging may be obtained for example from data/experience of previous calibration series for similar air springs, or the results of artificial aging from laboratory tests, and/or the results of model calculations.

An embodiment includes that a change reflecting the aging of the air spring takes the form of a modified gradient of the pressure curve compensating for aging. Such a modified gradient, which can still be described by a simple mean value, found from laboratory tests for artificial aging of air springs, of the gradient for the age-dependent pressure curve, allows a correspondingly precise measurement of wheel load and/or axle load over the operating life of an air spring.

The same applies to a further embodiment which includes that the change reflecting the aging of the air spring takes the form of an offset of the pressure curve compensating for the aging.

An embodiment includes that the pressure curves showing a change reflect the diameter change of the air spring over its operating period. Such a diameter change adequately reflects all aging processes in the air spring, namely aging processes within the material layers and also aging processes within the strength carrier. This gives an indicator, very simple to determine, for the influence of the spring aging as a whole on the pressure curve.

A further embodiment includes that the determination of the wheel load or axle load from pressure curves showing a change is carried out at temporal or event-related intervals, in particular after expiry of predefined periods, after reaching predefined operating times of the vehicle or after predefined events. Predefined time periods or predefined operating times are self-explanatory and/or depend on the corresponding legal regulations. Predefined events may for example include a replacement of air springs as part of regular maintenance or following damage or accident.

A further embodiment includes that the wheel load or axle load is determined continuously using pressure curves showing a change. Thus for example pressure curves modified incrementally in real time may form the basis of the respective measurements.

A further embodiment includes that the wheel load or axle load is determined by an algorithm stored in electronic control device of the air suspension of the vehicle, and the algorithm reacts to signals from sensors cooperating with the control device and/or accesses contents of memories present in the control device which contain data describing the course of the modified pressure curves, calculation specifications for determining the wheel load or axle load, and predefined data on the periods, operating times or events. With such a configuration, the method according to the disclosure becomes part of regular electronic routine in the vehicle, which can be carried out in real time by the control device or algorithm stored therein and retrieved any time.

An operator of the vehicle in which the method according to the disclosure is used therefore has no need to perform time-consuming calibration at regular intervals. The axle load is automatically compensated and there is no additional cost.

A further embodiment includes that, depending on a distance travelled by the vehicle, the pressure curve showing a change is configured such that in comparison with an air spring which has been newly brought into operation, for the same internal pressure of the spring, an at least 2% higher wheel load or axle load is determined.

Such an embodiment of the method effectively uses a product-dependent constant, via which it is possible to take sufficiently precise account of the different production methods or configurations/constructions of springs. Thus manufacturer-specific or production-specific constants can be introduced, such that a particular constant is defined for a particular configuration or particular spring type. From previous experience, it has been found that a constant which, for the same air spring internal pressure, gives an at least 2% higher wheel load or axle load from the (modified) pressure curve, takes account of most of these different configurations or types of air springs.

The same applies to a further embodiment in which, depending on the distance travelled by the vehicle, the pressure curve showing a change is modified in steps such that, in comparison with an air spring which has been newly brought into operation, for the same internal pressure of the spring, a higher wheel load or axle load is determined as follows:
after 25,000 km, an at least 0.5% higher wheel load or axle load,
after 50,000 km, an at least 0.9% higher wheel load or axle load,
after 75,000 km, an at least 1.2% higher wheel load or axle load, and
after 100,000 km, an at least 1.4% higher wheel load or axle load.

With such a stepped format, the essentially existing parameters affecting aging, including an existing load profile or the mass acting on the spring over time or the use of spring carrier loads, can be clearly simulated and illustrated by a modified pressure curve. Naturally, such a pressure curve, which is linear at least in steps, can also be replaced by a pressure curve to be described with a corresponding curve function.

A further embodiment includes that, depending on service life of an air spring, the pressure curve showing a change is modified every month such that, in comparison with an air spring which has been newly brought into operation, for the same internal pressure of the spring, a 0.5% higher wheel load or axle load is determined. This constitutes a very simple adaptation, averaged over a large number of air springs, or a change in the pressure curve, and can be used virtually as a monthly change in the base curve if there are no further specifications.

Naturally, other aging phenomena within the suspension may have effects on the curves. Depending on configuration, bearing sleeves or rubber bearings may influence load measurements over the usage time. Although from previous estimates, such influences have been negligible in comparison with the change in effective diameter of an air spring over its operating time, with corresponding interpretation and evaluation of results of previous tests, the characteristic curves can indeed reflect these influences but at the cost of comparability between different suspension configurations. Since this influence is very slight, for the improved method according to the disclosure, it is quite sufficient to take account of the curve change from the aging of the air spring.

In particular, the method according to the disclosure is naturally suitable for use within a ride height control device of an air-sprung vehicle, in particular an air-sprung goods vehicle, in particular an air-sprung truck or truck trailer, with a control device having an algorithm for performance of the method. Such height-control devices are particularly suitable for trucks or truck trailers which in future, even more than today, will have to comply with regulations and legislation.

### BRIEF DESCRIPTION OF DRAWINGS

The invention will now be described with reference to the drawings wherein:

FIG. 1 shows as an example a diagram with a pressure curve for an air spring; and,

FIG. 2 shows pressure curves for determining the wheel load or axle load of an air-sprung vehicle, which were used to perform the method according to the disclosure.

### DETAILED DESCRIPTION

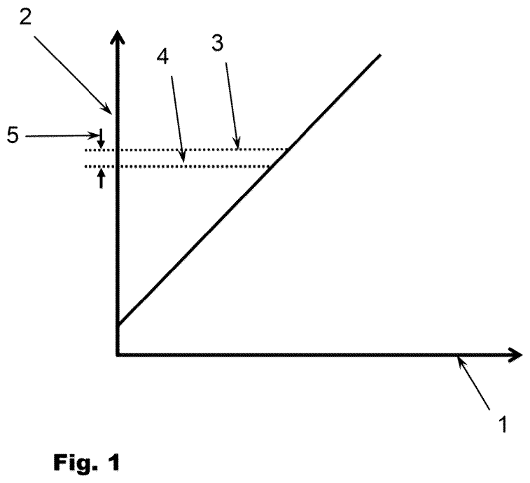

FIG. 1 shows purely as an example a diagram with a pressure curve for an air spring in which a spring internal pressure 1 is shown on the abscissa and an associated load 2, acting vertically on the air spring, is shown on the ordinate. The active surface area Aw of the air spring, determined by the effective diameter of the spring, as a parameter forms the basis of the relationship between the spring internal pressure 1 and the axially acting load 2 according to the equation

$$P = \frac{F}{{A}_{w}}$$

After aging and material fatigue of the air spring, the effective diameter and hence the effective area is enlarged so that a modified curve would be required, which would then be based on the enlarged active surface area calculated from the increased active diameter.

If the original pressure curve is always used when determining the bearing load via the spring internal pressure, a same internal pressure of the air spring would in fact, after a certain amount of aging, correspond to a higher load of the air spring, which would lead to incorrect values for the wheel load and axle load being measured and acknowledged.

FIG. 1 shows as a sketch and as an example how a measured value for the load 2 shifts downward as the spring ages. The dotted line shows as an example an axle load value for a new air spring 3 and an axle load value for an aged spring 4 under otherwise equal conditions. A (negative) axle load offset 5 is formed between the axle load value for the new air spring 3 and the axle load value for the aged air spring 4.

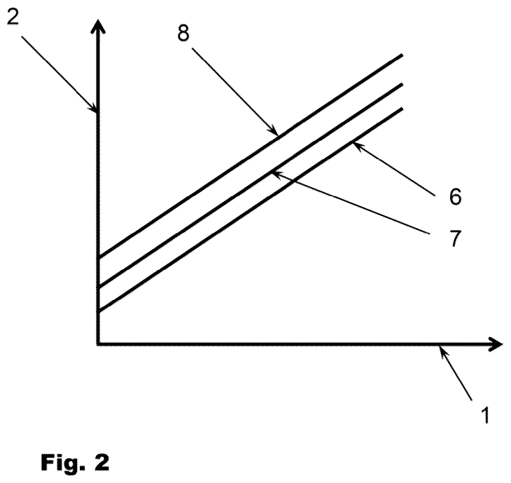

FIG. 2 illustrates an embodiment of the method according to the disclosure in which pressure curves 6, 7 and 8 were used to determine the wheel load or axle load of an air-sprung vehicle. In this embodiment, the change reflecting the aging of the air spring and/or the axle bearings or mountings takes the form of an offset of the pressure curves compensating for aging.

In FIG. 2, the pressure curve 6 represents the original pressure curve in the new condition of the air spring. The pressure curves 7 and 8 are formed such that irrespective of distance travelled by the vehicle, in comparison with an air spring which has been newly brought into operation with the pressure curve 6, for the same air spring internal pressure, an at least 2% higher wheel load or axle load can be determined. The pressure curves 6 and 7 constitute modified curves which should be taken into account when the vehicle has travelled 25,000 km and 50,000 km respectively.

The embodiment in FIG. 2 is based on the following values:

An unloaded vehicle has a mass of 4500 kg, whereby for a new air spring, the spring internal pressure, measured according to pressure curve 6 without load, amounts to 0.5 bar. If this vehicle is now loaded with a mass of 22,500 kg, it gives a total mass of 27,000 kg and an internal pressure of 6.5 bar in the new air spring.

After the vehicle has travelled 25,000 km, for further measurements initially the pressure curve 7 is used which, with the same gradient, is offset relative to the pressure curve 6 such that, for the same spring internal pressure, an at least 2% higher load, that is, wheel load or axle load, is determined.

If the internal pressure in the air spring is now measured taking into account the pressure curve 7, a spring internal pressure of 6.5 bar in loaded state no longer corresponds to a mass of 27,000 kg, but a mass of 27,540 kg loading the spring, that is, a load almost half a ton greater. Since the vehicle weight and the load mass are usually distributed over multiple air springs, such an increase can easily fall outside the permitted tolerance range and trigger corresponding measures on vehicle inspection. If one relied solely on the original pressure curve of a new air spring, this would lead to substantially incorrect measurements.

After the vehicle has travelled 50,000 km, for further measurements initially the pressure curve 8 is used which, with the same gradient, is offset relative to the pressure curve 6 such that, for the same internal pressure of the spring/air spring, an at least 4% higher wheel load or axle load is determined.

Apart from this embodiment, the changes in the curves may also be determined empirically in the form of modified gradients, by combinations of gradients and offsets, or in the form of curve functions.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF DESCRIPTION)

1 Spring internal pressure
2 Load
3 Axle load value for a new air spring
4 Axle load value for an aged air spring
5 Axle load offset
6 Pressure curve of an air spring in new condition
7 Pressure curve of an air spring after 25,000 km travel
8 Pressure curve of an air spring after 50,000 km travel

1. A method for determining a wheel load or an axle load of an air-sprung vehicle, the method comprising:
measuring the internal pressure of an air spring and determining the wheel load or the axle load using an original pressure curve which represents a relationship between a bearing force acting on the air spring and the measured internal pressure of the air spring; and,
starting from a wheel load or axle load determined by the pressure measurement, using the original pressure curve of an air spring which has been newly brought into operation, performing further pressure measurements using a further pressure curve which, in comparison with the original pressure curve, shows change reflecting an aging of the air spring.

2. The method of claim 1, wherein the change reflecting the aging of the air spring takes a form of a modified gradient of the further pressure curve compensating for the aging.

3. The method of claim 1, wherein the change reflecting the aging of the air spring is an offset of the further pressure curve compensating for the aging.

4. The method of claim 1, wherein the further pressure curve showing change reflects a diameter change of the air spring over an operating period of the air spring.

5. The method of claim 1, wherein the determination of the wheel load or axle load from the further pressure curve showing change is carried out at temporal or event-related intervals, in particular after expiry of predefined periods, after reaching predetermined operating times of the vehicle or after predefined events.

6. The method of claim 1, wherein said determination of the wheel load or axle load from the further pressure curve showing change is carried out after expiry of predefined periods after reaching predetermined operating times of the vehicle or after predefined events.

7. The method of claim 1, wherein the wheel load or axle load is determined continuously using pressure curves showing change.

8. The method of claim 1, wherein the wheel load or axle load is determined by an algorithm stored in an electronic control device of the air suspension of the vehicle, and the algorithm reacts to signals from sensors cooperating with the control device and/or accesses contents of memories present in the control device which contain data describing a course of a modified pressure curve, calculation specifications for determining the wheel load or axle load, and predefined data on periods, operating times or events.

9. The method of claim 1, wherein, in dependence upon a distance travelled by the vehicle, the further pressure curve showing change is configured such that, in comparison with the air spring which has been newly brought into operation, for a same internal pressure of the air spring, an at least 2% higher wheel load or axle load is determinable.

10. The method of claim 1, wherein in dependence upon a distance travelled by the vehicle, the further pressure curve showing change is modified in steps such that, in comparison with the air spring which has been newly brought into operation, for a same internal pressure of the air spring, a higher wheel load or axle load can be determined as follows:
after 25,000 km, an at least 0.5% higher wheel load or axle load,
after 50,000 km, an at least 0.9% higher wheel load or axle load,
after 75,000 km, an at least 1.2% higher wheel load or axle load, and
after 100,000 km, an at least 1.4% higher wheel load or axle load.

11. The method of claim 1, wherein depending on a service life of the air spring, the pressure curve showing a change is modified every month such that, in comparison with the air spring which has been newly brought into operation, for a same internal pressure of the air spring, a 0.5% higher wheel load or axle load is determined.

12. The method of claim 1, wherein the air-sprung vehicle is an air-sprung goods vehicle.

13. A ride height control device of an air-sprung vehicle comprising a non-transitory computer readable storage medium having an algorithm for performing the method of claim 1 stored thereon.

14. The ride height control device of claim 13, wherein the air-sprung vehicle is a an air-sprung goods vehicle.

15. The ride height control device of claim 13, wherein the air-sprung vehicle is an air-sprung truck or truck trailer.

16. A vehicle with a ride height control device as claimed in claim 13.

17. The vehicle of claim 16, wherein the vehicle is a goods vehicle.

18. The vehicle of claim 16, wherein the vehicle is a truck or truck trailer.
